(19) United States
(12) Patent Application Publication
(10) Pub. No.: US 2018/0276195 A1
(43) Pub. Date: Sep. 27, 2018

(54) ERROR-CORRECTING WORD DISPLAYING METHOD AND APPARATUS, DEVICE AND STORAGE MEDIUM

(71) Applicant: BEIJING BAIDU NETCOM SCIENCE AND TECHNOLOGY CO., LTD., Beijing (CN)

(72) Inventors: Ming MA, Beijing (CN); Tian QIN, Beijing (CN); Kefeng MENG, Beijing (CN)

(73) Assignee: BEIJING BAIDU NETCOM SCIENCE AND TECHNOLOGY CO., LTD., Beijing (CN)

(21) Appl. No.: 15/922,748

(22) Filed: Mar. 15, 2018

(30) Foreign Application Priority Data
Mar. 24, 2017 (CN) 201710184167.1

(51) Int. Cl. G06F 17/27; G06F 17/24

(52) U.S. Cl. CPC G06F 17/273; G06F 3/04883; G06F 17/276; G06F 17/24

(57) ABSTRACT

The present disclosure provides an error-correcting word displaying method and apparatus, a device and a storage medium, wherein the method comprises: obtaining a user-input input code; obtaining a discreteness evaluation result of the input code; determining an error-correcting adjustment policy according to the discreteness evaluation result; displaying the error-correcting word corresponding to the input code according to the error-correcting adjustment policy. The solution of the present disclosure may be used to improve the accuracy of display results.

The present application claims the priority of Chinese Patent Application No. 201710184167.1, filed on Mar. 24, 2017, with the title of “Error-correcting word displaying method and apparatus, device and storage medium”, the entire disclosure of which is hereby incorporated by reference in its entirety.

### FIELD OF THE DISCLOSURE

The present disclosure relates to computer application technologies, and particularly to an error-correcting word displaying method and apparatus, a device and a storage medium.

### BACKGROUND OF THE DISCLOSURE

Currently, along with intelligentization, mobility and fragmentation of various application scenarios, people are increasingly accustomed to operating on a portable smart terminal to complete his own daily demands such as shopping, travel, social communication, news and information browsing and the like. The smart terminal may include a mobile phone, tablet computer, vehicle-mounted device and the like.

Correspondingly, a mobile input method as a human-machine interaction means draws increasing attention, and iteration of its technology becomes faster and faster.

At present, mainstream mobile input methods in the industry all boost the user's experience under scenarios such as miss-input, less-input or miss-contact in a manner of supporting smart error correction.

FIG. 1 is a schematic diagram of an error-correcting example in the prior art. As shown in FIG. 1, the user inputs “wi”, it is highly probably corrected to “wo”, and [symbol] , as a preferred candidate, is displayed to the user.

FIG. 2 is a schematic diagram of another error-correcting example in the prior art. As shown in FIG. 2, the user inputs “vun”, it is highly probably corrected to “bun”, and “ [symbol] ”, as a preferred candidate, is displayed to the user.

However, the above smart error-correcting manner has certain problems in practical application, for example, under the scenario that the user inputs precisely, too many and improper error-correcting words might be given.

For example, if the input code input by the user is “bengkui”, in addition to the precise word “ [symbol] ”, error-correcting words “ [symbol] ” (‘g’ is considered as extra input) and “ [symbol] ” (‘k’ is corrected to ‘1’, and ‘i’ is corrected to ‘o’) are also displayed.

However, these error-correcting words are usually not be needed (not selected) by the user so that the accuracy of displaying results is reduced.

### SUMMARY OF THE DISCLOSURE

In view of the above, the present disclosure provides an error-correcting word displaying method and apparatus, a device and a storage medium, which can improve the accuracy of display results.

Specific technical solutions are as follows:

An error-correcting word displaying method, comprising:

obtaining a user-input input code;

obtaining a discreteness evaluation result of the input code;

determining an error-correcting adjustment policy according to the discreteness evaluation result;

displaying the error-correcting word corresponding to the input code according to the error-correcting adjustment policy.

An error-correcting word displaying apparatus, comprising: a collecting unit, an evaluating unit and an adjusting unit;

the collecting unit is configured to obtain an input code input by a user and send the input code to the evaluating unit;

the evaluating unit is configured to obtain a discreteness evaluation result of the input code and send the discreteness evaluation result to the adjusting unit;

the adjusting unit is configured to determine an error-correcting adjustment policy according to the discreteness evaluation result, and display error-correcting words corresponding to the input code according to the error-correcting adjustment policy.

A computer device, comprising a memory, a processor and a computer program which is stored on the memory and runs on the processor, the processor, upon executing the program, implementing the above-mentioned method.

A computer-readable storage medium on which a computer program is stored, the program, when executed by the processor, implementing the aforesaid method.

As can be seen from the above introduction, the solutions of the present disclosure may be employed to perform discreteness evaluation for the user-input input code to obtain the discreteness evaluation result, then determine an error-correcting adjustment policy according to the discreteness evaluation result, and display the error-correcting word corresponding to the input code according to the determined error-correcting adjustment policy, namely, to perform flexible adjustment of the display manner of the error-correcting words according to the user's input situations, thereby improving the accuracy of display results as compared with the prior art.

### BRIEF DESCRIPTION OF DRAWINGS

FIG. 1 is a schematic diagram of an error-correcting example in the prior art.

FIG. 2 is a schematic diagram of another error-correcting example in the prior art.

FIG. 3 is a schematic diagram of a comparison result of two test groups according to the present disclosure.

FIG. 4 is a flow chart of an error-correcting word displaying method according to an embodiment of the present disclosure.

FIG. 5 is a block diagram of an error-correcting word displaying apparatus according to an embodiment of the present disclosure.

FIG. 6 illustrates a block diagram of an example computer system/server 12 adapted to implement an implementation mode of the present disclosure.

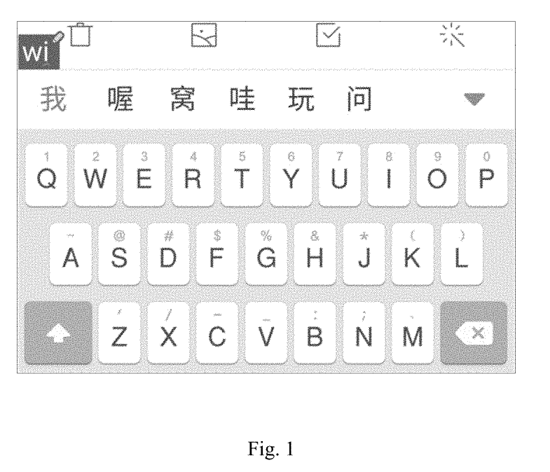

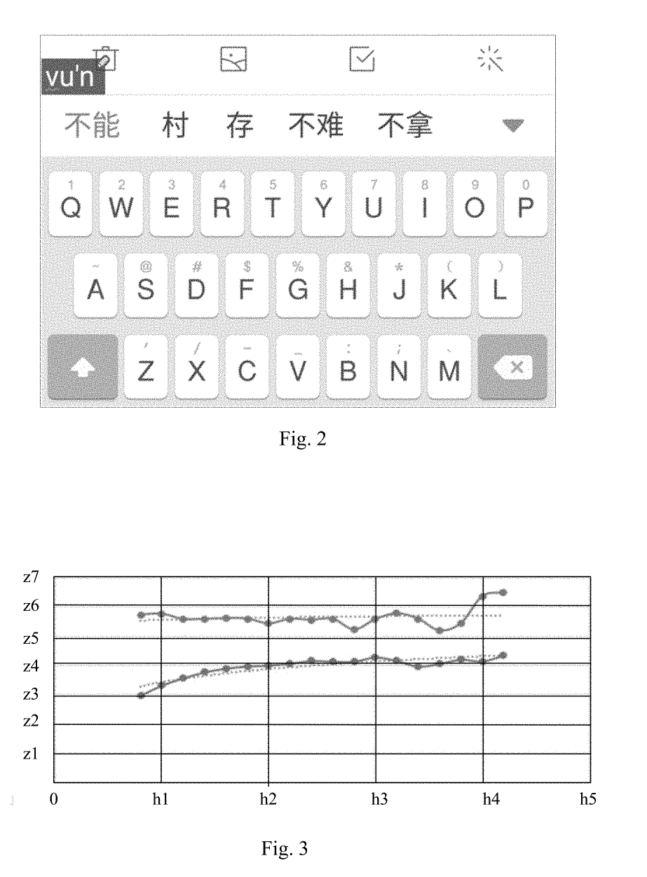

### DETAILED DESCRIPTION OF PREFERRED EMBODIMENTS

In view of problems existing in the prior art, the present disclosure provides an improved error-correcting word displaying method, according to which a discreteness evaluation result of input codes input by the user is obtained by evaluating quality of the user's input of each time from a discrete degree of falling points of keys, and the error-correcting degree is adjusted according to the discreteness evaluation result to give an error-correcting policy conforming to actual situations without affecting the user's experience of precise input.

A series of test corpuses may be collected. Each test corpus may include: an input code and a selected candidate word in one time of input that actually happened in the past. The selected candidate word may be precise word or an error-correcting word.

Furthermore, the text corpuses may be divided into two test groups. In one test group, what are selected are all precise words, and in another test group, what are selected are error-correcting words. Correspondingly, the two test groups may be respectively called a precise word test group and an error-correcting word test group.

It is feasible, for each test group, to respectively determine a discreteness evaluation result of the input code in each test corpus, and then compare the two test groups according to the determination results.

As shown in FIG. 3, FIG. 3 is a schematic diagram of a comparison result of the two test groups according to the present disclosure, wherein a transverse coordinate denotes a length of the input code, for example, the length of the input code “women” is 5, and a longitudinal coordinate denotes the discreteness evaluation result. In addition, an upper curve corresponds to the error-correcting word test group, and a lower curve corresponds to the precise word test group.

As can be seen from FIG. 3, in most cases, the two curves are spaced apart further, i.e., the two test groups is largely distinct in the discrete degree, thereby verifying feasibility of the solution of the present disclosure.

Technical solutions of the present disclosure will be described in more detail in conjunction with figures and embodiments to make technical solutions of the present disclosure clear and more apparent.

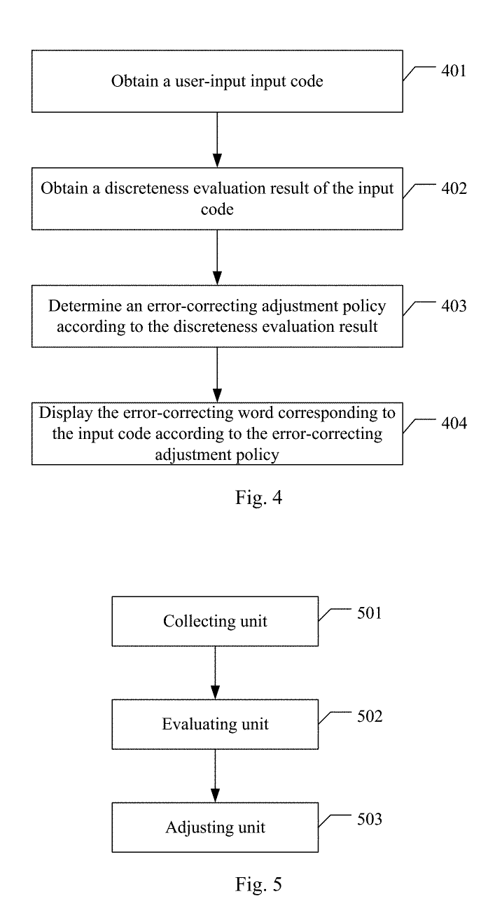

FIG. 4 is a flow chart of an error-correcting word displaying method according to an embodiment of the present disclosure. As shown in FIG. 4, the embodiment comprises the following specific implementation mode.

In 401, a user-input input code is obtained.

For example, the input code may be “women”, and the user may input each sub-code therein in turn, and the sub-codes form the input code in the input order.

It is possible to, while obtaining the user-input each sub-code, obtain falling point coordinates of each sub-code in the input code, and determine the discreteness evaluation result of the input code according to the falling point coordinates of each sub-code.

In 402 is obtained a discreteness evaluation result of the input code.

It is feasible to determine the discreteness evaluation result of the input code according to falling point coordinates of respective sub-codes after respectively obtaining the falling point coordinates of the respective sub-codes in the input code.

Specifically, the discreteness evaluation result of the input code may be obtained by calculation. The calculating manner includes but is not limited to: variance of distance, sum of squares, any simple function with the distance as a dependent variable, such as power function, exponential function, logarithmic function, trigonometric function and inverse trigonometric function, or a complex function related thereto.

For example, the discreteness evaluation result S of the input code may be obtained in the following manner:

$$S = \frac{{\sum }_{P ( {P}_{x} , {P}_{y} ) ∈ T} [ {( {P}_{x} - {X}_{τ} )}^{2} + {( {P}_{y} - {Y}_{τ} )}^{2} ]}{\vert T \vert} ; \qquad ( 1 )$$

Wherein (X_{τ}, Y_{τ}) denotes coordinates of a center of a click response area corresponding to any sub-code i in the input code, (Pₓ, P_{y}) denotes falling point coordinates of the sub-code i, and T denotes a set of respective falling point coordinates.

In 403, an error-correcting adjustment policy is determined according to the discreteness evaluation results.

After the discreteness evaluation result of the input code is calculated, it is feasible to input the discreteness evaluation result to a preset mapping function to thereby obtain a mapping value, and determine an error-correcting adjustment policy corresponding to the mapping value, and consider the determined error-correcting adjustment policy as a desired error-correcting adjustment policy.

That is, R=E(S) (2)

Wherein E denotes the mapping function, R denotes the mapping value, and S denotes the discreteness evaluation result.

E may be a piecewise function or a continuous function. The specific function form is not limited and may be decided according to actual needs.

It is possible to preset the error-correcting adjusting policies respectively corresponding to different mapping values. A specific policy depends on actual needs.

The adjustment may comprise any one of the following or any combination thereof:

adjusting weight of error-correcting words, adjusting the number of displayed error-correcting words and adjusting display positions of error-correcting words and the like.

For example, it is possible to decrease or increase the weight of the error-correcting words. The magnitude of the weight affects a display sequence/position of the error-correcting words in the display results. It is feasible to limit the number of the displayed error-correcting words, limit the number of error-correcting words occurring before the precise word, or the like.

In 404, the error-correcting word corresponding to the input code is displayed according to the error-correcting adjustment policy.

In the prior art, when the user inputs the input code, the precise words and error-correcting words which correspond to the input code and are all usually in plurality are determined respectively. The determined precise words and error-correcting words may be sorted in a predetermined manner and then displayed to the user.

On this basis, it is feasible to determine the error-correcting adjustment policy in the manner stated in the present disclosure, and display error-correcting words corresponding to the input code according to the error-correcting adjustment policy, namely, display the error-correcting words according to the error-correcting word adjustment policy, for example, display the error-correcting words according to the limited number of displayed error-correcting words, display the error-correcting words according to the number of error-correcting words occurring before the precise word, or the like.

As compared with the prior art, in the solution of the present disclosure, it is possible to perform flexible adjustment of the display manner of the error-correcting words according to the user's input situations, thereby improving the accuracy of display results.

On this basis, the following optimization measures may be taken to further optimize and improve the solution of the present disclosure.

1) Optimization Manner 1

Before obtaining the discreteness evaluation result of the input code input by the user, it is feasible to first filter away sub-codes incompliant with predetermined requirements from the input code, and then obtain the discreteness evaluation result of the input code after the filtration processing.

That is, the sub-codes incompliant with predetermined requirements in the input code are considered as noise and filtered away, and the filtered-away sub-codes will not participate in the calculation of the discreteness evaluation result. How to filter is not limited and depends on actual needs.

For example, if a deviation between the falling point coordinates of a certain sub-code and the coordinates of a center of the click response area corresponding to the sub-cod is larger than a predetermined threshold, the sub-code may be filtered away.

Again for example, if the number of keys between the key corresponding to a certain sub-code and a desired key is larger than a predetermined threshold, the sub-code may be filtered away.

Calculating the discreteness evaluation result after the filtration may make the algorithm more adaptive and the calculation result more accurate.

2) Optimization Manner 2

It can be seen from the above introduction that the discreteness is in an association relationship with the length of the input code. Hence, it is feasible to input the discreteness evaluation result and the length of the input code simultaneously into a preset mapping function to obtain a mapping value and then determine the error-correcting adjustment policy corresponding to the mapping value.

That is, the mapping function in formula (2) may be optimized, and formula (2) becomes as follows:

R=E(S, L); (3)

L represents the length of the input code.

Fineness of the algorithm may be improved through formula (3).

3) Optimization Manner 3

The discreteness index varies might vary with different resolutions. It is feasible to employ an equal-scale scaling algorithm or a resolution fitting algorithm to eliminate the deviation caused by the difference in resolutions.

The equal-scale scaling algorithm may mean, before determining the discreteness evaluation result of the input code according to the falling point coordinates of sub-codes, first determining whether to perform standardization processing for falling points of the sub-codes in the input code; if yes, performing standardization processing for falling points of sub-codes in the input code, and determining the discreteness evaluation result of the input code according to the falling point coordinates of sub-codes after the standardization processing.

The resolution fitting algorithm may mean inputting the discreteness evaluation result, the length of the input code and resolution information of the input method panel into a preset mapping function to obtain a mapping value and determine the error-correcting adjustment policy corresponding to the mapping value.

R=E(S, L, U_{w}, Uₕ);

Wherein U_{w} and Uₕ respectively represent a width and height of the resolution of the input method panel.

In practical application, the solution of the present disclosure may be combined with a current input method model in an embedded manner or an add-on manner.

The above introduces the method embodiment. The solution of the present disclosure will be further described through an apparatus embodiment.

FIG. 5 is a block diagram of an error-correcting word displaying apparatus according to an embodiment of the present disclosure. As shown in FIG. 5, the apparatus comprises a collecting unit 501, an evaluating unit 502 and an adjusting unit 503.

The collecting unit 501 is configured to obtain an input code input by a user and send the input code to the evaluating unit 502. The evaluating unit 502 is configured to obtain a discreteness evaluation result of the input code and send the discreteness evaluation result to the adjusting unit 503.

The adjusting unit 503 is configured to determine an error-correcting adjustment policy according to the discreteness evaluation result, and display error-correcting words corresponding to the input code according to the error-correcting adjustment policy.

The input code input by the user is comprised of a series of sub-codes. The sub-codes forms the input code in an input order, for example, the input code is “women”, wherein w is one of the sub-codes.

While obtaining the user-input sub-codes, the collecting unit 501 may further obtain falling point coordinates of sub-codes, and send the sub-codes and their falling point coordinates to the evaluating unit 502.

Correspondingly, the evaluating unit 502 may determine the discreteness evaluation result of the input code according to falling point coordinates of the respective sub-codes.

The evaluating unit 502 may calculate to obtain the discreteness evaluation result of the input code. The calculating manner includes but is not limited to: variance of distance, sum of squares, any simple function with the distance as a dependent variable, such as power function, exponential function, logarithmic function, trigonometric function and inverse trigonometric function, or a complex function related thereto.

The adjusting unit 503 may input the discreteness evaluation result obtained from the evaluating unit 502 to a preset mapping function to obtain a mapping value and then determine an error-correcting adjustment policy corresponding to the mapping value.

It is possible to preset the error-correcting adjusting policies respectively corresponding to different mapping values. A specific policy depends on actual needs.

The adjustment may comprise any one of the following or any combination thereof:

adjusting weight of error-correcting words, adjusting the number of displayed error-correcting words and adjusting display positions of error-correcting words and the like.

For example, it is possible to decrease or increase the weight of the error-correcting words. The magnitude of the weight affects a display sequence/position of the error-correcting words in the display results. It is feasible to limit the number of the displayed error-correcting words, limit the number of error-correcting words occurring before the precise word, or the like.

The adjusting unit 503 may display the error-correcting word corresponding to the input code according to the error-correcting adjustment policy.

On this basis, the following optimization measures may be taken:

The evaluating unit 502, before obtaining the discreteness evaluation result of the input code, first filters away sub-codes incompliant with predetermined requirements from the input code, and then obtain the discreteness evaluation result of the input code after the filtration processing;

In addition, the adjusting unit 503 may input the discreteness evaluation result and a length of the input code into a preset mapping function to obtain a mapping value and then determine the error-correcting adjustment policy corresponding to the mapping value;

The adjusting unit 503 may input the discreteness evaluation result, the length of the input code and resolution information of the input method panel into a preset mapping function to obtain a mapping value and determine the error-correcting adjustment policy corresponding to the mapping value.

Further, the evaluating unit 502 may further, before determining the discreteness evaluation result of the input code according to the falling point coordinates of sub-codes, determine whether to perform standardization processing for falling points of the sub-codes in the input code; if yes, perform standardization processing for falling points of sub-codes in the input code respectively, and determine the discreteness evaluation result of the input code according to the falling point coordinates of sub-codes after the standardization processing.

A specific workflow of the apparatus embodiment shown in FIG. 5 will not be detailed any more here, and reference may be made to corresponding depictions in the above method embodiment.

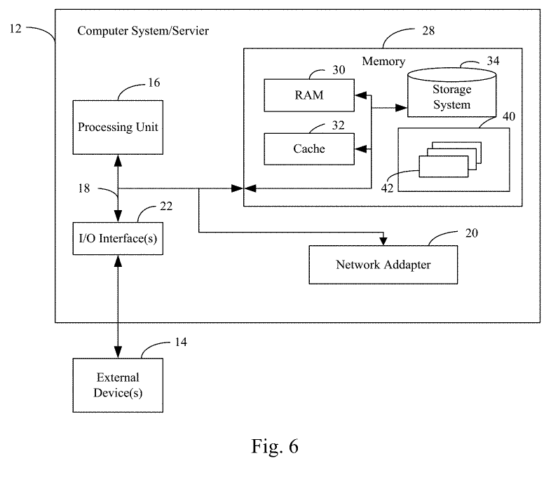

FIG. 6 illustrates a block diagram of an example computer system/server 12 adapted to implement an implementation mode of the present disclosure. The computer system/server 12 shown in FIG. 6 is only an example and should not bring about any limitation to the function and scope of use of the embodiments of the present disclosure.

As shown in FIG. 6, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 6 and typically called a “hard drive”). Although not shown in FIG. 6, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 6, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 4, namely, obtain a user-input input code, obtain the discreteness evaluation result of the input code, determine an error-correcting adjustment policy according to the discreteness evaluation result, and display the error-correcting word corresponding to the input code according to the error-correcting adjustment policy.

Reference may be made to relevant depictions in the above method embodiment for specific implementation, which will not be detailed any more here.

The present disclosure further provides a computer-readable storage medium on which a computer program is stored. The program, when executed by a processor, can implement the method in the embodiment shown in FIG. 4.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. An error-correcting word displaying method, wherein the method comprises:
obtaining a user-input input code;
obtaining a discreteness evaluation result of the input code;
determining an error-correcting adjustment policy according to the discreteness evaluation result;
displaying the error-correcting word corresponding to the input code according to the error-correcting adjustment policy.

2. The method according to claim 1, wherein
the obtaining a discreteness evaluation result of the input code comprises:
respectively obtaining falling point coordinates of each sub-codes in the input code, the sub-codes forming the input code in an input order;
determining the discreteness evaluation result of the input code according to falling point coordinates of each sub-codes.

3. The method according to claim 1, wherein
the determining an error-correcting adjustment policy according to the discreteness evaluation result comprises:
inputting the discreteness evaluation result to a preset mapping function to obtain a mapping value;
determining an error-correcting adjustment policy corresponding to the mapping value.

4. The method according to claim 1, wherein
before obtaining the discreteness evaluation result of the input code, the method further comprises:
filtering away sub-codes incompliant with predetermined requirements from the input code, the sub-codes forming the input code in an input order;
obtaining the discreteness evaluation result of the input code after the filtration processing.

5. The method according to claim 1, wherein
the determining an error-correcting adjustment policy according to the discreteness evaluation result comprises:
inputting the discreteness evaluation result and a length of the input code into a preset mapping function to obtain a mapping value;
determining the error-correcting adjustment policy corresponding to the mapping value.

6. The method according to claim 1, wherein
the determining an error-correcting adjustment policy according to the discreteness evaluation result comprises:
inputting the discreteness evaluation result, the length of the input code and resolution information of the input method panel into a preset mapping function to obtain a mapping value;
determining the error-correcting adjustment policy corresponding to the mapping value.

7. The method according to claim 2, wherein
before determining the discreteness evaluation result of the input code according to the falling point coordinates of each sub-codes, the method further comprises:
determining whether to perform standardization processing for falling points of each sub-codes in the input code;
if yes, performing standardization processing for falling points of each sub-codes in the input code respectively, and determining the discreteness evaluation result of the input code according to the falling point coordinates of each sub-codes after the standardization processing.

8-14. (canceled)

15. A computer device, comprising a memory, a processor and a computer program which is stored on the memory and runs on the processor, wherein the processor, upon executing the program, implements the following operation:
obtaining a user-input input code;
obtaining a discreteness evaluation result of the input code;
determining an error-correcting adjustment policy according to the discreteness evaluation result;
displaying the error-correcting word corresponding to the input code according to the error-correcting adjustment policy.

16. A computer-readable storage medium on which a computer program is stored, wherein the program, when executed by the processor, implements the following operation:
obtaining a user-input input code;
obtaining a discreteness evaluation result of the input code:
determining an error-correcting adjustment policy according to the discreteness evaluation result;
displaying the error-correcting word corresponding to the input code according to
the error-correcting adjustment policy.

17. The computer device according to claim 15, wherein
the obtaining a discreteness evaluation result of the input code comprises:
respectively obtaining falling point coordinates of each sub-codes in the input code, the sub-codes forming the input code in an input order;
determining the discreteness evaluation result of the input code according to falling point coordinates of each sub-codes.

18. The computer device according to claim 15, wherein
the determining an error-correcting adjustment policy according to the discreteness evaluation result comprises:
inputting the discreteness evaluation result to a preset mapping function to obtain a mapping value;
determining an error-correcting adjustment policy corresponding to the mapping value.

19. The computer device according to claim 15, wherein
before obtaining the discreteness evaluation result of the input code, the method further comprises:
filtering away sub-codes incompliant with predetermined requirements from the input code, the sub-codes forming the input code in an input order;
obtaining the discreteness evaluation result of the input code after the filtration processing.

20. The computer device according to claim 15, wherein
the determining an error-correcting adjustment policy according to the discreteness evaluation result comprises:
inputting the discreteness evaluation result and a length of the input code into a preset mapping function to obtain a mapping value;
determining the error-correcting adjustment policy corresponding to the mapping value.

21. The computer device according to claim 15, wherein
the determining an error-correcting adjustment policy according to the discreteness evaluation result comprises:
inputting the discreteness evaluation result, the length of the input code and resolution information of the input method panel into a preset mapping function to obtain a mapping value;
determining the error-correcting adjustment policy corresponding to the mapping value.

22. The computer device according to claim 17, wherein
before determining the discreteness evaluation result of the input code according to the falling point coordinates of each sub-codes, the operation further comprises:
determining whether to perform standardization processing for falling points of each sub-codes in the input code;
if yes, performing standardization processing for falling points of each sub-codes in the input code respectively, and determining the discreteness evaluation result of the input code according to the falling point coordinates of each sub-codes after the standardization processing.

23. The computer-readable storage medium according to claim 16, wherein
the obtaining a discreteness evaluation result of the input code comprises:
respectively obtaining falling point coordinates of each sub-codes in the input code, the sub-codes forming the input code in an input order;
determining the discreteness evaluation result of the input code according to falling point coordinates of each sub-codes.

24. The computer-readable storage medium according to claim 16, wherein
the determining an error-correcting adjustment policy according to the discreteness evaluation result comprises:
inputting the discreteness evaluation result to a preset mapping function to obtain a mapping value;
determining an error-correcting adjustment policy corresponding to the mapping value.

25. The computer-readable storage medium according to claim 16, wherein
before obtaining the discreteness evaluation result of the input code, the method further comprises:
filtering away sub-codes incompliant with predetermined requirements from the input code, the sub-codes forming the input code in an input order;
obtaining the discreteness evaluation result of the input code after the filtration processing.

26. The computer-readable storage medium according to claim 16, wherein
the determining an error-correcting adjustment policy according to the discreteness evaluation result comprises:
inputting the discreteness evaluation result and a length of the input code into a preset mapping function to obtain a mapping value;
determining the error-correcting adjustment policy corresponding to the mapping value.

27. The computer-readable storage medium according to claim 16, wherein
the determining an error-correcting adjustment policy according to the discreteness evaluation result comprises:
inputting the discreteness evaluation result, the length of the input code and resolution information of the input method panel into a preset mapping function to obtain a mapping value;
determining the error-correcting adjustment policy corresponding to the mapping value.

28. The computer-readable storage medium according to claim 23, wherein
before determining the discreteness evaluation result of the input code according to the falling point coordinates of each sub-codes, the operation further comprises:
determining whether to perform standardization processing for falling points of each sub-codes in the input code;
if yes, performing standardization processing for falling points of each sub-codes in the input code respectively, and determining the discreteness evaluation result of the input code according to the falling point coordinates of each sub-codes after the standardization processing.
